(19) United States
(12) Patent Application Publication
(10) Pub. No.: US 2018/0251611 A1
(43) Pub. Date: Sep. 6, 2018

(54) FIBER-REINFORCED POLYPROPYLENE RESIN COMPOSITION

(71) Applicant: MAZDA MOTOR CORPORATION, Hiroshima (JP)

(72) Inventors: Yasushi OKADA, Nagoya-shi (JP); Yohei ICHIHARA, Hiroshima-shi (JP); Yusuke ASAKURA, Aki-gun (JP)

(73) Assignee: MAZDA MOTOR CORPORATION, Hiroshima (JP)

(21) Appl. No.: 15/759,448

(22) PCT Filed: Sep. 16, 2016
(86) PCT No.: PCT/JP2016/077452

§ 371 Date: Mar. 12, 2018

(30) Foreign Application Priority Data
Sep. 24, 2015 (JP) 2015-186848

(51) Int. Cl. C08J 5/04; C08L 23/16; C08K 5/20

(52) U.S. Cl. CPC C08J 5/044; C08L 23/16; C08K 5/20; C08F 210/14; C08F 2500/12; C08F 2500/07; C08J 2323/16

(57) ABSTRACT

A fiber-reinforced polypropylene-based resin composition including 53 mass % to 74.5 mass % of a component (A); 10 mass % to 20 mass % of a component (B); 15 to 25 mass % of a component (C); and 0.5 to 2 mass % of a component (D), where a sum of the components (A), (B), (C), and (D) is 100 mass %. The components (A), (B), (C), and (D) satisfy specific conditions. The composition further includes 0.05 to 0.15 pts.mass of a component (E) relative to 100 pts.mass of the sum of the components (A), (B), (C), and (D). The component (E) satisfies a specific condition.

### TECHNICAL FIELD

The present disclosure relates to a fiber-reinforced polypropylene-based resin composition, and more particularly to a fiber-reinforced polypropylene-based resin composition with a low-gloss embossed surface, and high heat and scratch resistance.

### BACKGROUND ART

Polypropylene-based resin compositions are becoming widely used as resin materials with excellent physical properties, moldability, recyclability, and cost efficiency in various fields. In particular, in the fields of vehicle components such as dashboards and pillars, and components of electric appliances such as televisions and vacuum cleaners, polypropylene-based resin and polypropylene-based resin compositions including their moldings are widely used due to their excellent moldability, physical property balance, recyclability, and cost efficiency. The polypropylene-based resin compositions include polypropylene-based composite resin formed by combining polypropylene-based resin with a filler such as glass fiber and talc, or an elastomer (rubber) for reinforcement.

These fields, particularly the field of vehicle interior components increasingly experience quality improvements such as a higher function, a larger size, and a wider and more complicated application of moldings of polypropylene-based resin compositions. To cope with such quality improvements or for other purposes, not only an improvement in the moldability and the physical property balance of polypropylene-based resin compositions and their moldings, but also a decrease in gloss and an increase in heat and scratch resistance, which largely influence excellence in the texture of the compositions and their moldings.

According to a widely used method, a polypropylene-based resin composition and its molding contain a filler such as glass fiber and talc to increase the rigidity (strength) of the resin composition and its molding. For example, Patent Document 1 discloses a high strength, high rigidity polyolefin-based resin composition with mechanical strength equal to or higher than that of a polyamide-based resin reinforced with glass fiber. Specifically, Patent Document 1 discloses, as such a polyolefin-based resin composition, a high strength, high rigidity polyolefin-based thermoplastic resin composition containing: (A) a polypropylene-based resin mixture; (B) a polyolefin-based resin; and (C) a filler. The mixture is mainly composed of polypropylene obtained by sequential polymerization of two or more stages. Propylene-ethylene copolymer rubber in the mixture has an average dispersed particle size of 2 μm or less. The filler has an average diameter of 0.01 to 1000 μm, and an average aspect ratio (length/diameter) of 5 to 2500. The document describes that a molding of the composition has high tensile, bending, Izod impact, and falling-weight impact strength and a high bending elastic modulus. However, the document fails to discuss the gloss, heat resistance, and scratch resistance of the molding. Insufficient properties are thus expected from the molding.

Patent Document 2 discloses a highly processable thermoplastic elastomer composition. The composition has excellent surface characteristics such as a smooth texture (free from stickiness and slipperiness, and less strained and damaged). The composition contains no element which may generate toxic gas. Specifically, Patent Document 2 discloses, as such a thermoplastic elastomer composition, a composition containing 0.2 to 5.0 pts.wt. of higher fatty acid amide relative to 100 pts.wt. of a mixed composition of a propylene-ethylene copolymer and a hydrogenated diene-based copolymer, and 0.05 to 5.0 pts.wt. of a surfactant relative to 100 pts.wt. of the mixed composition. The mixed composition is obtained by combining 80 to 50 pts.wt. of the hydrogenated diene-based copolymer with 20 to 50 pts.wt. of the propylene-ethylene copolymer. The document describes that the composition has a smooth texture (free from stickiness). These characteristics are however not expected to work in the field of, for example, vehicle interior components which require higher rigidity and strength. The composition is thus less applicable to such a field, and considered to have a problem in heat resistance.

On the other hand, compositions with improved physical properties and texture are also suggested. For example, Patent Document 3 discloses a polymer molding composition advantageous in manufacturing a molding due to its high rigidity, high scratch resistance and significantly pleasant, soft touch. Specifically, Patent Document 3 discloses, as such a polymer molding composition, a polymer molding composition containing at least 5 to 90 wt. % of a soft material, and, as a filler, a combination of 5 to 60 wt. % of a glass material and 3 to 70 wt. % of a thermoplastic polymer. The document describes that the composition and its molding have high rigidity, low surface hardness, high scratch resistance, and pleasantly soft touch. However, the document fails to discuss the gloss, heat resistance, and bending elastic modulus of the composition and its molding. Insufficient properties are thus expected from the molding.

Each of Patent Documents 4 and 5 discloses a low shrinking fiber-reinforced propylene-based resin composition with excellent transferability to embossed surfaces and high scratch resistance. The fiber-reinforced propylene-based resin composition is obtained by combining a propylene based resin composition with an elastomer and, as a filler, a glass material and carbon fiber in presence of a metallocene catalyst. Each document describes that the composition has high transferability, low shrinkage, excellent load-deflection characteristics, and high scratch resistance. However, the document fails to discuss a gloss change after thermal duration. Insufficient performance is thus expected from the molding.

As the forgoing, to increase rigidity, polypropylene-based resin compositions often need to contain a filler, which tends to increase the gloss and reduce the scratch resistance of the composition. On the other hand, to increase impact resistance, for example, an elastomer and a soft polyolefin often need to be contained, which tend to reduce rigidity and heat resistance. That is, improvements in these characteristics at the same time have been difficult.

### CITATION LIST

### Patent Document

PATENT DOCUMENT 1: Japanese Unexamined Patent Publication No. 2002-3691
PATENT DOCUMENT 2: Japanese Unexamined Patent Publication No. H7-292212
PATENT DOCUMENT 3: Japanese Unexamined Patent Publication (Japanese Translation of PCT Application) No. 2009-506177
PATENT DOCUMENT 4: Japanese Unexamined Patent Publication No. 2013-67789
PATENT DOCUMENT 5: Japanese Unexamined Patent Publication No. 2014-132073

### SUMMARY

### Technical Problem

In view of the problems of the known art, it is an objective of the present disclosure to provide a fiber-reinforced polypropylene-based resin composition with low gloss, a small gloss change after thermal duration, high scratch and heat resistance, and high rigidity.

### Solution to the Problem

As a result of close researches, the present inventors found that the problems are solved by a fiber-reinforced polypropylene-based resin composition, in which a specific propylene-ethylene block copolymer contains glass fiber, a specific thermoplastic elastomer, erucic acid amide, and a specific modified polyolefin at a specific ratio. The present disclosure was made based on the finding.

Specifically, a first aspect of the present disclosure provides a fiber-reinforced polypropylene-based resin composition including

53 mass % to 74.5 mass % of a component (A);

10 mass % to 20 mass % of a component (B);

15 to 25 mass % of a component (C); and

0.5 to 2 mass % of a component (D);

where a sum of the components (A), (B), (C), and (D) is 100 mass %.

The components (A), (B), (C), and (D) satisfy conditions indicated below.

The composition further includes 0.05 to 0.15 pts.mass of a component (E)

relative to 100 pts.mass of the sum of the components (A), (B), (C), and (D).

The component (E) satisfies a condition indicated below.

The component (A) satisfies requirements defined by the following (A-i) to (A-iv).

(A-i) The component (A) is a propylene-ethylene block copolymer obtained by sequential polymerization of 30 mass % to 95 mass % of a component (A-A) in a first step and 70 mass % to 5 mass % of a component (A-B) in a second step using a metallocene-based catalyst. The component (A-A) is a propylene homopolymer component or a propylene-ethylene random copolymer component containing 7 mass % or less of ethylene. The component (A-B) is a propylene-ethylene random copolymer component containing 3 mass % to 20 mass % more ethylene than the component (A-A).

(A-ii) A melting peak temperature (Tm) measured by DSC falls within a range from 110° C. to 150° C.

(A-iii) A tan δ curve has a single peak at 0° C. or lower in a temperature-loss tangent curve obtained by solid viscoelasticity measurement.

(A-iv) A melt flow rate (MFR) of the component (A) (at 230° C. and a load of 2.16 kg) falls within a range from 0.5 g/10 min to 200 g/10 min

The component (B) satisfies a requirement defined by the following (B-i).

(B-i) The component (B) is glass fiber.

The component (C) satisfies requirements defined by the following (C-i) to (C-ii).

(C-i) The component (C) is an ethylene-octene copolymer with a density of 0.85 g/cm³ to 0.87 g/cm³.

(C-ii) A melt flow rate of the component (C) (at 230° C. and a load of 2.16 kg) falls within a range from 0.5 g/10 min to 1.1 g/10 min

The component (D) satisfies a requirement defined by the following (D-i).

(D-i) The component (D) is an acid-modified polyolefin and/or a hydroxy-modified polyolefin.

The component (E) satisfies a requirement defined by the following (E-i).

(E-i) The component (E) is erucic acid amide.

A second aspect of the present disclosure provides the fiber-reinforced polypropylene-based resin composition of the first aspect, in which the component (B) has a length within a range from 0.2 mm to 10 mm.

### Advantages of the Invention

The fiber-reinforced polypropylene-based resin composition according to the present disclosure has low gloss, high scratch and heat resistance, and, in addition, high rigidity.

The composition is thus advantageously used for, for example, not only vehicle interior components such as dashboards, glove boxes, console boxes, armrests, grip knobs, various trims such as door trims, ceiling components, and various housings, but also components of electric and electronic appliances such as televisions and vacuum cleaners, various industrial components, house components such as toilet seats, and building components.

### BRIEF DESCRIPTION OF THE DRAWINGS

FIG. 1 illustrates an amount of elution and a cumulative amount of elution obtained by temperature rising elution fractionation (TREF).

### DESCRIPTION OF EMBODIMENTS

This embodiment relates to a fiber-reinforced polypropylene-based resin composition containing a specific propylene-ethylene block copolymer (A), glass fiber (B), a specific thermoplastic elastomer (C), a specific modified polyolefin (D), and erucic acid amide (E) at a specific ratio.

The components and the fiber-reinforced polypropylene-based resin composition to be obtained in this embodiment will now be described in detail.

### 1. Component (A)

The component (A) used in this embodiment satisfies requirements (A-i) to (A-iv).

(A-i) The component (A) is a propylene-ethylene block copolymer obtained by sequential polymerization of 30 mass % to 95 mass % of a component (A-A) in a first step and 70 mass % to 5 mass % of a component (A-B) in a second step using a metallocene-based catalyst. The component (A-A) is a propylene homopolymer component or a propylene-ethylene random copolymer component containing 7 mass % or less of ethylene. The component (A-B) is a propylene-ethylene random copolymer component containing 3 mass % to 20 mass % more ethylene than the component (A-A).

(A-ii) A melting peak temperature (Tm) measured by DSC falls within a range from 110° C. to 150° C.

(A-iii) A tan δ curve has a single peak at 0° C. or lower in a temperature-loss tangent curve obtained by solid viscoelasticity measurement.

(A-iv) A melt flow rate (MFR) of the component (A) (at 230° C. and a load of 2.16 kg) falls within a range from 0.5 g/10 min to 200 g/10 min.

### (1) Requirements

### Requirement (A-i)

The component (A) of this embodiment is a propylene-ethylene block copolymer. The propylene-ethylene block copolymer contain a low crystalline component, and thus provides the fiber-reinforced polypropylene-based resin composition (also simply referred to as the “resin composition”) of this embodiment with characteristics such as low gloss and high scratch resistance.

The propylene-ethylene block copolymer (A) used in this embodiment satisfies the requirement (A-i). Specifically, the propylene-ethylene block copolymer (A) is produced by sequential polymerization of 30 mass % to 95 mass % of a component (A-A) in a first step and 70 mass % to 5 mass % of a component (A-B) in a second step using a metallocene-based catalyst. The component (A-A) is a propylene homopolymer component or a propylene-ethylene random copolymer component containing 7 mass % or less, 5 mass % or less in one preferred embodiment, and 3 mass % or less in one more preferred embodiment, of ethylene. The component (A-B) is a propylene-ethylene random copolymer component containing 3 mass % to 20 mass % more, 6 to 18 mass % more in one preferred embodiment, and 8 to 16 mass % more in one more preferred embodiment, ethylene than the component (A-A). Satisfaction of the requirement (A-i) allows a molding, which may be formed from the resin composition of this embodiment, to have a low-gloss surface. This enables production of such moldings in an industrial scale. If the difference in the ethylene content between the second-step component (A-B) and the first-step component (A-A) is, for example, less than 3 mass %, a molding to be formed from the obtained resin composition would have a surface with higher gloss (with degraded non-glossy characteristics). On the other hand, if the difference is more than 20 mass %, the components (A-A) and (A-B) are less compatible with each other. As a result, a molding, which may be formed from the obtained resin composition, would have a surface with higher gloss (with degraded non-glossy characteristics). In addition, manufacturing problems such as adhesion of a reaction product to a reactor may occur. This may hinder manufacturing of such moldings in an industrial scale.

That is, the propylene-ethylene block copolymer (A) is obtained by sequential polymerization of the components containing different contents of ethylene between the first and second steps. As a result, the resin composition and its molding have excellent non-glossy characteristics. In order to reduce manufacturing problems such as adhesion of a reaction product to a reactor, it is important to polymerize the component (A-B) after the component (A-A).

### (i) Metallocene-Based Catalyst

The use of a metallocene-based catalyst is required to produce the propylene-ethylene block copolymer (A) used in this embodiment.

The metallocene-based catalyst is not particularly limited, as long as the propylene-ethylene block copolymer (A) used in this embodiment can be produced. To meet the requirements of this embodiment, the metallocene-based catalyst containing, for example, the following components (a), (b), and, as necessary, (c) is used in one preferred embodiment.

Component (a): at least one metallocene transition metal compound selected from transition metal compounds represented by a general formula (1) indicated below

Component (b): at least one solid component selected from the following (b-1) to (b-4)

(b-1): a fine particle carrier carrying an organoaluminumoxy compound

(b-2): a fine particle carrier carrying an ionic compound capable of reacting with the component (a)) so as to convert the component (a)) to a cation, or a Lewis acid

(b-3): solid acid fine particles

(b-4): ion-exchangeable layered silicate

Component (c): organoaluminum compound

As the component (a), at least one metallocene transition metal compound selected from transition metal compounds represented by the following general formula (1) may be used.

Q(C₅H₄-aR₁ₐ)(C₅H₄-bR_{2b})MₑXY (1)

In the formula, Q represents a divalent bonding group crosslinking two conjugated five-membered rings. Q is, for example, a divalent hydrocarbon, silylene, or oligosilylene group; a silylene or oligosilylene group containing a hydrocarbon group as a substituent; or a germylene group containing a hydrocarbon group as a substituent. Out of these, a divalent hydrocarbon group and a silylene group containing a hydrocarbon group as a substituent are used in preferred embodiments.

X and Y represent, for example, a hydrogen atom, a halogen atom, a hydrocarbon group, an alkoxy group, an amino group, a nitrogen-containing hydrocarbon group, a phosphorus-containing hydrocarbon group, or a silicon-containing hydrocarbon group. Out of these, for example, hydrogen, chlorine, methyl, isobutyl, phenyl, dimethyl amide, and a diethyl amide group may be used in preferred embodiments. X and Y may be independent from each other, that is, may be the same or different from each other.

R₁ₐ and R_{2b} represent hydrogen, a hydrocarbon group, a halogenated hydrocarbon group, a silicon-containing hydrocarbon group, a nitrogen-containing hydrocarbon group, an oxygen-containing hydrocarbon group, a boron-containing hydrocarbon group, or a phosphorus-containing hydrocarbon group. Specifically, the hydrocarbon group is, for example, a methyl group, an ethyl group, a propyl group, a butyl group, a hexyl group, an octyl group, a phenylgroup, a naphthyl group, a butenyl group, or a butadienyl group. Typical examples of the halogenated hydrocarbon group, the silicon-containing hydrocarbon group, the nitrogen-containing hydrocarbon group, the oxygen-containing hydrocarbon group, the boron-containing hydrocarbon group, or the phosphorus-containing hydrocarbon group may include a methoxy group, an ethoxy group, a phenoxy group, a trimethylsilyl group, a diethylamino group, a diphenylamino group, a pyrazolyl group, an indolyl group, a dimethyl phosphino group, a diphenylphosphino group, a diphenylboron group, and a dimethoxyboron group. Out of these, 1 to 20C hydrocarbon groups are used in one preferred embodiment, and a methyl group, an ethyl group, a propyl group, and a butyl group are used in one more preferred embodiment. The adjacent R₁ₐ and R_{2b} may be bonded together to form a ring. The ring may have a substituent consisting of a hydrocarbon group, a halogenated hydrocarbon group, a silicon-containing hydrocarbon group, a nitrogen-containing hydrocarbon group, an oxygen-containing hydrocarbon group, a boron-containing hydrocarbon group, or a phosphorus-containing hydrocarbon group.

Mₑ represents a metal atom selected from titanium, zirconium, and hafnium. Zirconium or hafnium in one preferred embodiment.

Note that a and b represent numbers of substituents.

Out of the above examples of the component (a), a transition metal compound composed of a ligand having substituted cyclopentadienyl, indenyl, fluorenyl, and azulenyl groups crosslinked with a silylene, germylene or alkylene group having a hydrocarbon substituent is selected in one preferred embodiment to produce the propylene-ethylene block copolymer (A) used in this embodiment. In one particularly preferred embodiment, a transition metal compound composed of a ligand having 2,4-substituted indenyl and azulenyl groups crosslinked with a silylene or germylene group having a hydrocarbon substituent is selected.

Specific examples include, without limitation, dimethylsilylene-bis(2-methyl-4-phenylindenyl)zirconium dichloride, diphenylsilylene-bis(2-methyl-4-phenylindenyl)zirconium dichloride, dimethylsilylene-bis(2-methylbenzoindenyl)zirconium dichloride, dimethylsilylene-bis{2-isopropyl-4-(3, 5-diisopropyl phenyl)indenyl}zirconium dichloride, dimethylsilylene-bis(2-propyl-4-phenanthrylindenyl)zirconium dichloride, dimethylsilylene-bis(2-methyl-4-phenylazulenyl)zirconium dichloride, dimethylsilylene-bis{2-methyl-4-(4-chlorophenyl)azulenyl}zirconium dichloride, dimethylsilylene-bis(2-ethyl-4-phenylazulenyl)zirconium dichloride, dimethylsilylene-bis(2-isopropyl-4-phenylazulenyl)zirconium dichloride, dimethylsilylene-bis{2-ethyl-4-(2-fluorobiphenyl)azulenyl}zirconium dichloride, and dimethylsilylene-bis{2-ethyl-4-(4-t-butyl-3-chlorophenyl)azulenyl}zirconium dichloride. Compounds obtained by substituting a silylene group with a germylene group and zirconium with hafnium in these specific exemplary compounds are also regarded as examples of advantageous compounds. The catalyst component is not a particularly important element in this embodiment. To avoid complicated explanation, merely representative examples are provided, which are obviously not intended to limit the effective scope of the present disclosure.

At least one solid component selected from the components (b-1) to (b-4) are used as the component (b). These components are known, and selected from the known art as appropriate. Specific examples and manufacturing methods are described in detail, for example, in Japanese Unexamined Patent Publication No. 2002-284808, Japanese Unexamined Patent Publication No. 2002-53609, Japanese Unexamined Patent Publication No. 2002-69116, and Japanese Unexamined Patent Publication No. 2003-105015.

Out of the examples of the component (b), the component (b-4) ion-exchangeable layered silicate is selected in one particularly preferred embodiment. In one more preferred embodiment, ion-exchangeable layered silicate subjected to chemical treatment such as acid treatment, alkali treatment, salt treatment, and organic substance treatment is selected.

Examples of organoaluminum compound used as the component (c) as necessary include trialkylaluminum such as trimethylaluminum, triethylaluminum, tripropylaluminum, and triisobutylaluminum, or halogen- or alkoxy-containing alkylaluminum such as diethylaluminum monochloride and diethylaluminum monomethoxide represented by the following general formula (2):

AlRₐP₍₃₋ₐ₎ (2)

where R represents a C1 to 20 hydrocarbon group, P reprints a hydrogen, halogen or alkoxy group, and a represents a number within a range of 0<a≤3.

In addition, for example, aluminoxane such as methylaluminoxane may be used. Out of these, trialkylaluminum is particularly used in one preferred embodiment.

The catalyst is formed by bringing the components (a), (b), and, as necessary, (c) to come into contact with each other. Any known type of contact method may be used without limitation, as long as the catalyst can be formed.

Any amount of the components (a), (b), and (c) may be used. For example, relative to 1 g of the component (b), the amount of the component (a) to be used falls within a range from 0.1 to 1,000 μmol in one preferred embodiment, and from 0.5 to 500 μmol in one particularly preferred embodiment. Relative to 1 g of the component (b), the amount of transition metal of the component (c) to be used falls within a range from 0.001 to 100 μmol in one preferred embodiment, and from 0.005 to 50 μmol in one particularly preferred embodiment.

Furthermore, in one preferred embodiment, the catalyst used in this embodiment is subjected to prepolymerization, in which the catalyst comes into contact with olefin in advance to polymerize a small amount of olefin.

A commercial product may also be used as the propylene-ethylene block copolymer (A) polymerized using the metallocene-based catalyst. For example, WELNEX™ series manufactured by Japan Polypropylene Corporation may be used advantageously.

### (ii) Sequential Polymerization

Sequential polymerization of the components (A-A) and (A-B) is required to produce the propylene-ethylene block copolymer (A) used in this embodiment.

The sequential polymerization may be performed by a batch method or a continuous method. In general, the continuous method is more desirably used in view of productivity.

In the batch method, the components (A-A) and (A-B) may be polymerized using a single reactor by changing polymerization conditions with time. A plurality of reactors may also be connected in parallel for use, as long as the advantages of this embodiment are not impaired.

The continuous method requires equipment for production, which is formed by connecting two or more reactors in series to polymerize the components (A-A) and (A-B) individually. A plurality of reactors may be connected in series and/or parallel for use for each of the components (A-A) and (A-B), as long as the advantages of this embodiment are not impaired.

(iii) Polymerization Process

Any polymerization type such as a slurry process, a bulk process, or a vapor phase process may be used to polymerize the propylene-ethylene block copolymer (A). These polymerization types may be combined. A supercritical condition may be used as an intermediate condition between the bulk and vapor phase processes. The supercritical condition is substantially equivalent to the vapor phase process, and thus not distinguished from, that is, included in the vapor phase process.

There is no particular problem to produce the component (A-A) by any process. If the component (A-A) with relatively low crystallinity is to be produced, the vapor phase process is used in one preferred embodiment to reduce problems such as adhesion of the product to a reactor.

The component (A-B) is readily soluble in an organic solvent such as hydrocarbon or liquefied propylene. The vapor phase process is thus used in one preferred embodiment to produce the component (A-B).

Therefore, in one most preferred embodiment, the continuous method is used to polymerize the component (A-A) first by the bulk or vapor phase process, and then, polymerize the component (A-B) by the vapor phase process.

### (iv) Other Polymerization Conditions

The polymerization temperature may fall within a range usually used without any problems. Specifically, the polymerization temperature falls within a range from 0° C. to 200° C., and, in one more preferred embodiment, from 40° C. to 100° C.

Optimal polymerization pressures are different from process to process to be selected. The polymerization pressure may fall within a range usually used without any problems. Specifically, the polymerization pressure is higher than 0 MPa and equal to or lower than 200 MPa, and falls within a range from 0.1 MPa to 50 MPa in one more preferred embodiment, relative to atmospheric pressure. At this time, inert gas such as nitrogen may coexist.

In the case where the component (A-A) is polymerized in the first step, and the component (A-B) is polymerized in the second-step in the sequential polymerization, a polymerization inhibitor is desirably added to the reaction system in the second step. The addition of the polymerization inhibitor to the reactor, which performs ethylene-propylene random copolymerization in the second step, improves the particle properties (e.g., fluidity) of the powder to be obtained and the quality of the product such as gel. Various technical studies were made for this technique. For example, Publications such as Japanese Examined Patent Publication No. S63-54296, Japanese Unexamined Patent Publication No. H7-25960, and Japanese Unexamined Patent Publication No. 2003-2939 describe exemplary methods. Application of this technique is also desirable in this embodiment.

The propylene-ethylene block copolymer (A) used in this embodiment contains a low crystallinity component. In particular, the component (A-B) delays the progress of cooling solidification in the molding process. The propylene-ethylene block copolymer (A) provides the resin composition and its molding with characteristics such as low gloss.

The propylene-ethylene block copolymer (A) in this specification is a commonly known block copolymer obtained by the sequential polymerization of the propylene homopolymer component or the propylene-ethylene random copolymer component, and the propylene-ethylene random copolymer component as defined by (A-i). In the propylene-ethylene block copolymer (A), the components (A-A) and (A-B) are not necessarily bonded in complete blocks.

Two or more types may be used together as the propylene-ethylene block copolymer (A).

The ethylene contents of the components (A-A) and (A-B) are determined as follows.

### (i) Temperature Rising Elution Fractionation (TREF) and Calculation of T(C)

Evaluating crystallinity distribution in the propylene-ethylene block copolymer (A) by temperature rising elution fractionation (also simply referred to as TREF) is well known to those skilled in the art. For example, the following document shows detailed measurement methods.

G. Glockner, J. Appl. Polym. Sci.: Appl. Polym. Symp.; 45, 1-24 (1990)

L. Wild, Adv. Polym. Sci.; 98, 1-47 (1990)

J. B. P. Soares, A. E. Hamielec, Polymer; 36, 8, 1639-1654 (1995)

For example, the components (A-A) and (A-B) of this embodiment are characterized by TREF.

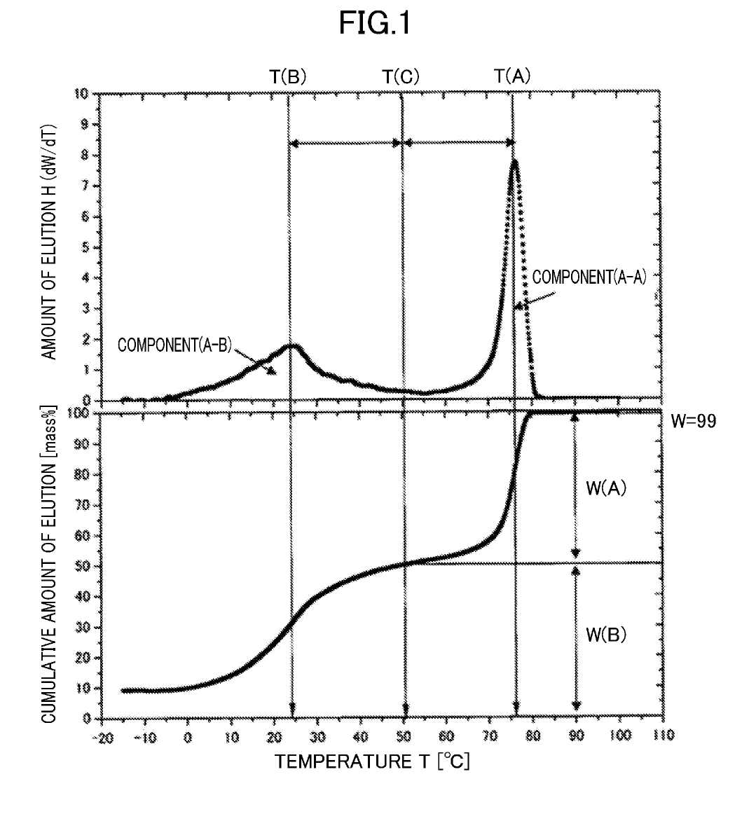

A specific method will be described with reference to FIG. 1 showing the amount of elution and the cumulative amount of elution obtained by TREF. In a TREF elusion curve (a plot of the amount of elution with respect to the temperature), the components (A-A) and (A-B) have elusion peaks at T(A) and T(B), respectively, which are attributed to the difference in crystallinity. Since there is a sufficiently large difference between T(A) and T(B), fractionation is almost possible at an intermediate temperature T(C)(={T(A)+T(B)}/2).

In the apparatus used in this measurement, the lower limit of the TREF measurement temperature is −15° C. If the component (A-B) has extremely low or no crystallinity, the component (A-B) may have no peak within the measurement temperature range in this measurement method. In this case, the concentration of the component (A-B) dissolved in the solvent at the lower limit of the measurement temperature (i.e., −15° C.) is detected.

At this time, T(B) is considered to be lower than or equal to the lower limit of the measurement temperature. However, since the value cannot be measured, T(B) is determined as −15° C., which is the lower limit of the measurement temperature.

Assume that the cumulative amount of the eluted component up to T(C) is W(B) mass %, and the cumulative amount of the eluted component from T(C) is W(A) mass %. W(B) almost corresponds to the amount of the component (A-B) with low or no crystallinity The cumulative amount W(A) of the eluted component from T(C) corresponds to the amount of the component (A-A) with relatively high crystallinity. The elution amount curve obtained by TREF and various temperatures and amounts obtained from the curve are calculated by a method shown in FIG. 1.

### TREF Measurement Method

In this embodiment, TREF is specifically measured as follows. A sample is dissolved at 140° C. in orthodichlorobenzene (ODCB), which contains 0.5 mg/m L of BHT, to be a solution. The solution is introduced into a TREF column of 140° C., and then cooled down to 100° C. at a temperature drop rate of 8° C./min. The solution is continuously cooled down to −15° C. at a temperature drop rate of 4° C./min and maintained for 60 minutes. After that, the solvent ODCB, which contains 0.5 mg/mL of BHT, is flowed to the column at a flow rate of 1 mL/min In the TREF column, the component dissolved in ODCB at a temperature of −15° C. is eluted for 10 minutes. The temperature of the column is linearly raised up to 140° C. at a temperature rise rate of 100° C./h to obtain the elusion curve.

The outline of the apparatus and other elements used in this embodiment are as follows. Equivalent apparatus may be used to determine the curve.

TREF column: stainless steel column with 4.3 mmφ×150 mm

Column filler: glass beads in a size of 100 μm with an inactivated surface

Heating system: aluminum heating block

Cooling system: Peltier element (cooled with water)

Temperature distribution: ±0.5° C.

Temperature controller: digital program controller KP1000 (valve oven) of CHINO Corporation

Heating system: air-bath oven

Temperature at measurement: 140° C.

Temperature Distribution: ±1° C.

Valve: six-way valve, four-way valve

Injection system: loop injector

Detector: fixed-wavelength infra-red detector MIRAN 1A manufactured by FOXBORO

Detection wavelength: 3.42 μm

High-temperature flow cell: micro flow cell for LC-IR with an optical path length of 1.5 mm, a window size of 2φ×4 mm in an elliptical shape, and a synthetic sapphire window plate

Concentration of sample: 5 mg/mL

Amount of sample to be injected: 0.1 mL

### (ii) Fractionation of Components (A-A) and (A-B)

Based on T(C) obtained by the TREF described above, the component (A-B) soluble at T(C) and the component (A-A) insoluble at T(C) are fractionated by temperature rising column fractionation using a prep fractionator. The ethylene contents of the components are obtained by NMR.

For example, the following document shows specific measurement methods of the temperature rising column fractionation.

Macromolecules; 21, 314-319 (1988)

Specifically, the following method is used in this embodiment.

### Fractionation Conditions

A cylindrical column with a diameter of 50 mm and a height of 500 mm is filled with a glass bead carrier (80 to 100 mesh) and maintained at 140° C.

Next, 200 mL of a sample ODCB solution (10 mg/mL) dissolved at 140° C. is introduced into the column The column is then cooled to 0° C. at a temperature drop rate of 10° C./h. The column is maintained at 0° C. for one hour, and then heated to T(C) at a temperature rise rate of 10° C./h and maintained at T(C) for one hour. Throughout these processes, the temperature of the column is controlled with an accuracy of ±1° C.

While the temperature of the column is maintained at T(C), 800 mL of ODCB of T(C) is flowed at a flow rate of 20 mL/min to elute and recover the component present in the column and soluble at T(C).

After that, the temperature of the column is raised to 140° C. at a temperature rise rate of 10° C./min and maintained at 140° C. for one hour. Then, 800 mL of the solvent (ODCB) of 140° C. is flowed at a flow rate of 20 mL/min to elute and recover the component at T(C).

The solutions obtained by fractionation and containing polymer are concentrated to 20 mL using an evaporator to precipitate polymer in a 5-fold amount of methanol. The precipitated polymer is filtered, recovered, and then dried overnight using a vacuum dryer.

(iii) Measurement of Ethylene Content Using ¹³C-NMR

The ethylene contents of the components (A-A) and (A-B) obtained by the fractionation are determined by analyzing ¹³C-NMR spectra measured by complete proton decoupling. The method used in this embodiment will now be described as a representative example.

Type: GSX-400 (with a carbon nuclear resonance frequency of 400 MHz) manufactured by JEOL Ltd.

Solvent: ODCB/deuterated benzene=4/1 (volume ratio)

Concentration: 100 mg/mL

Temperature: 130° C.

Pulse angle: 90°

Pulse interval: 15 sec

Integration times: 5,000 or more

Spectra may be assigned with reference to, for example, the following document.

Macromolecules; 17, 1950 (1984)

Table 1 shows assignment of spectra measured under the conditions described above. In Table 1, symbols such as S. are in accordance with the notation in the following document, P represents methyl carbon, S represents methylene carbon, and T represents methyne carbon.

Carman, Macromolecules; 10, 536 (1977)

TABLE 1

| Chemical Shift (ppm) | Assignment |
|---|---|
| 45 to 48 | S_{αα} |
| 37.8 to 37.9 | S_{αγ} |
| 37.4 to 37.5 | S_{αδ} |
| 33.1 | T_{δδ} |
| 30.9 | T_{βδ} |
| 30.6 | S_{γγ} |
| 30.2 | S_{γδ} |
| 29.8 | S_{δδ} |
| 28.7 | T_{ββ} |
| 27.4 to 27.6 | S_{βδ} |
| 24.4 to 24.7 | S_{βδ} |
| 19.1 to 22.0 | P |

Six triads of PPP, PPE, EPE, PEP, PEE, and EEE may be present in the copolymer chain, where “P” represents a propylene unit and “E” represents an ethylene unit. As described in Macromolecules, 15, 1150 (1982), for example, the concentrations of these triads are correlated with the peak intensities in spectra using the following relations <1> to <6>.

[PPP]=k×I(T_{ββ}) <1>

[PPE]=k×I(T_{βδ}) <2>

[EPE]=k×I(T_{δδ}) <3>

[PEP]=k×I(S_{ββ}) <4>

[PEE]=k×I(S_{βδ}) <5>

[EEE]=k×[I(S_{δδ})/2+I(S_{γδ})/4} <6>

In the equations, the letters in the brackets └ ┘ represent the fractions of the triads. For example, [PPP] represents the fraction of the PPP triad among all triads.

Thus, the following equation is obtained:

[PPP]+[PPE]+[EPE]+[PEP]+[PEE]+[EEE]=1 <7>

In the equations, k is a constant and l represents the intensity of each spectrum. For example, I(T_{ββ}) represents the peak intensity at 28.7 ppm, which is assigned to T_{ββ}.

The fractions of the triads are obtained by the relational expressions <1> to <7>. Furthermore, the ethylene content is obtained by the following equation.

Ethylene Content(mol %)=([PEP]+[PEE]+[EEE])×100

The propylene random copolymer contains a small amount of propylene hetero bonds (2,1-bond and/or 1,3-bond), which causes the following small peaks.

TABLE 2

| Chemical Shift (ppm) | Assignment |
|---|---|
| 42.0 | S_{αα} |
| 38.2 | T_{αγ} |
| 37.1 | S_{αδ} |
| 34.1 to 35.6 | S_{αβ} |
| 33.7 | T_{γγ} |
| 33.3 | T_{γδ} |
| 30.8 to 31.2 | T_{βγ} |
| 30.5 | T_{βδ} |
| 30.3 | S_{αβ} |
| 27.3 | S_{βγ} |

Peaks derived from these hetero bonds need to be taken into account for calculation.to obtain a precise ethylene content. However, such peaks are difficult to completely resolve and identify, and only a small amount of the hetero bonds is contained. Thus, in this embodiment, the ethylene content is obtained by the relational expressions <1> to <7> like the analysis of copolymers, which contain substantially no hetero bonds and are produced using a Ziegler-Natta catalyst.

The ethylene content (mass %) is converted from the ethylene content (mol %) by the following expression:

Ethylene Content(mass %)=(28×X/100)/{28×X/100+42×(1−X/100)}×100,

where X is the ethylene content in mol %. The ethylene content [E]W of the entire propylene-ethylene block copolymer is calculated by the following expression:

[E]W=[E]A×W(A)+[E]B×W(B)}/100(mass %), where [E]A and [E]B represent the ethylene contents in the components (A-A) and (A-B), respectively, which have been measured as described above and W(A) and W(B) represent the mass percentages (mass %) of the respective components calculated by TREF.

### (A-ii) Melting Peak Temperature (Tm)

The melting peak temperature (also simply referred to as “Tm”) of the propylene-ethylene block copolymer (A) used in this embodiment measured by a differential scanning calorimetry calorimetry (DSC) method falls within a range from 110° C. to 150° C., from 115° C. to 148° C. in one preferred embodiment, from 120° C. to 145° C. in one more preferred embodiment, and 125 to 145° C. in one further more preferred embodiment.

A melting peak temperature (Tm) within these ranges allow a molding, which may be formed from the resin composition of this embodiment, to have sufficient rigidity and a low-gloss surface. Specifically, Tm lower than 110° C. may reduce the rigidity of the resin composition and its molding. On the other hand, Tm higher than 150° C. may increase the gloss (i.e., degrade the non-glossy characteristics) of a molding, which may be formed from the obtained resin composition. Tm can be controlled by a catalyst to be used or by adjusting the ethylene content to be copolymerized with propylene.

To measure Tm, 5.0 mg of a sample is taken, maintained at 200° C. for five minutes and crystallized to 40° C. at a temperature drop rate of 10° C./min. The sample is further melted at a temperature rise rate of 10° C./min. The peak temperature at this time is evaluated using a differential scanning calorimetry (e.g., DSC6200 manufactured by Seiko Instruments Inc. in this application).

### (A-iii): Tans Curve

A tan δ curve has a single peak at 0° C. or lower on a temperature-loss tangent curve, of the propylene-ethylene block copolymer (A) used in this embodiment, obtained by solid viscoelasticity measurement.

Specifically, in this embodiment, no phase separation of the components (A-A) and (A-B) should be performed in the propylene-ethylene block copolymer (A) so that a molding, which may be formed from the resin composition, has a low-gloss surface. If no phase separation is performed, the tan δ curve has a single peak at 0° C. or lower.

If the components (A-A) and (A-B) form a phase separation structure, the tan δ curve has a plurality of peaks, because the glass transition temperature of an amorphous part in the component (A-A) differs from that in the component (A-B).

Solid viscoelasticity measurement (DMA) is performed by applying a sinusoidal strain with a specific frequency to a strip-like sample piece, and detecting the generated stress. The frequency is here 1 Hz, and the measurement temperature is raised gradually from −60° C. until the sample is melted and the measurement is no more possible.

A recommended amount of strain falls within a range from about 0.1% to about 0.5%. The storage elastic modulus G′ and the loss elastic modulus G are calculated based on the obtained stress by a known method. The loss tangent defined by the ratio (i.e., the loss elastic modulus/the storage elastic modulus) is plotted against the temperature. The molding of the propylene-ethylene block copolymer (A) has a sharp peak in a temperature range of 0° C. or lower. In general, a peak of the tan δ curve at 0° C. or lower means that glass transition of the amorphous part is observed.

The solid viscoelasticity measurement (DMA) used in this embodiment is specifically described below. Any equivalent apparatus may be used for measurement.

As the sample, a strip with a width of 10 mm, a length of 18 mm, and a thickness of 2 mm is used, which has been cut out of a sheet having a thickness of 2 mm and being subjected to injection molding under the following conditions.

The apparatus ARES manufactured by Rheometric Scientific, Inc. is used.

Standard No.: JIS-7152 (150294-1)

Frequency: 1 Hz

Measurement temperature: The sample is heated gradually from −60° C. to be melted.

Strain: within a range from 0.1 to 0.5%
Molding machine: Injection Molding Machine EC20 manufactured by TOSHIBA MACHINE CO., LTD
Mold: strip-like test piece (60×80×2 t (mm)) for physical properties evaluation
Molding Conditions
   Molding temperature: 220° C.
   Temperature of mold: 40° C.
   Injection pressure: 50 MPa
   Injection period: 5 sec
   Cooling period: 20 sec

### (A-iv) Melt Flow Rate (MFR)

The melt flow rate (also simply referred to as MFR) of the propylene-ethylene block copolymer (A) used in this embodiment (at 230° C. and a load of 2.16 kg) falls, within a range from 0.5 to 200 g/10 min, from 1 to 150 g/10 min in one preferred embodiment, and from 5 to 100 g/10 min in one more preferred embodiment.

The MFR within these ranges allow a molding, which may be formed from the resin composition of this embodiment, to have sufficient impact resistance. This enables production of such moldings in an industrial scale. Specifically, an MFR lower than 0.5 g/10 min may cause difficulties, such as insufficient filling in injection molding, in production in the industrial scale. On the other hand, an MFR higher than 200 g/10 min may reduce impact resistance. The MFR can be controlled by adjusting the polymerization conditions (e.g., the polymerization temperature, the amount of hydrogen to be added), and/or using a molecular weight depressant.

The MFR is measured in accordance with JIS K7210 at a temperature of 230° C. and a load of 2.16 kg.

### (2) Q Value

The propylene-ethylene block copolymer (A) of this embodiment has a Q value within a range from 2 to 5 in one preferred embodiment, from 2.3 to 4.8 in one more preferred embodiment, and from 2.5 to 4.5 in one further more preferred embodiment. The Q value within these ranges allows a molding, which may be formed from the resin composition of this embodiment, to have a surface with various properties sufficiently higher than a practical level. Specifically, a Q value smaller than 2 may reduce the quality of the surface of a molding, which may be formed from the obtained resin composition. On the other hand, a Q value greater than 5 may increase the initial gloss (i.e., degrade the non-glossy characteristics) of a molding, which may be formed from the obtained resin composition. The Q value can be controlled by adjusting the catalyst and polymerization conditions, as well as the amount of a molecular weight depressant to be added.

The Q value is defined by the ratio (Mw/Mn) of the mass average molecular weight (Mw) to the number average molecular weight (Mn), which are measured by the gel permeation chromatography (GPC). Detailed GPC conditions in the present application are indicated below. Any equivalent apparatus may be used for measurement.

Apparatus: GPC 150C manufactured by Waters Corporation

Detector: 1A Infrared Spectrophotometer (with a measurement wavelength of 3.42 μm) manufactured by MIRAN

Column: three columns of AD806M/S manufactured by Showa Denko K.K. The columns were calibrated with measuring monodisperse polystyrene manufactured by Tosoh Corporation (0.5 mg/mL solutions of A500, A2500, F1, F2, F4, F10, F20, F40, and F288), and approximating logarithmic values of elution volume and molecular weight by a quadratic expression. The molecular weight of a sample was obtained by conversion into polypropylene using viscosity equations of polystyrene and polypropylene, where coefficients of the viscosity equation of polystyrene: α=0.723 and log K=−3.967, and coefficients of the viscosity equation of polypropylene: α=0.707 and log K=−3.616).

Measurement temperature: 140° C.

Concentration: 20 mg/10 ml

Amount of injection: 0.2 ml

Solvent: o-dichlorobenzene

Flow rate: 1.0 ml/min

### (3) Content

The content of the propylene-ethylene block copolymer (A) used in this embodiment falls within a range from 53 mass % to 74.5 mass %, from 55 to 72 mass % in one preferred embodiment, from 58 to 70 mass % in one more preferred embodiment, and 60 to 68 mass % in one further more preferred embodiment, where the sum of the components (A), (B), (C), and (D) is 100 mass %. The propylene-ethylene block copolymer (A) content within these ranges allows a molding, which may be formed from the resin composition of this embodiment, to have a surface with excellent initial non-glossy characteristics (i.e., sufficiently low gloss) as well as high rigidity. Specifically, a propylene ethylene random copolymer (A) content lower than 53 mass % may increase the initial gloss (i.e., degrade the non-glossy characteristics) of the surface of a molding, which may be formed from the fiber-reinforced composition of this embodiment. On the other hand, a propylene ethylene random copolymer (A) content higher than 74.5 mass % may reduce, for example, the rigidity.

### 2. Component (B)

The component (B) of this embodiment satisfies a requirement (B-i).

(B-i) The component (B) is glass fiber.

Glass fiber has a high tensile elastic modulus and high tensile strength, which increase the rigidity of the resin composition and its molding. Glass fiber is advantageous in increasing the hardness of the surface of a molding, which may be formed from the resin composition of this embodiment. This contributes to an increase in, for example, the scratch resistance. Glass fiber is used in one preferred embodiment in view of facility in producing the resin composition of this embodiment and cost efficiency.

Two or more types may be used together as the glass fiber (B). Alternatively, the propylene-ethylene block copolymer (A) containing, in advance, the glass fiber (B) at a relatively high concentration may be used in the form of a so-called masterbatch.

Any type of inorganic or organic filler, such as talc, mica, glass beads, glass balloons, whisker, or organic fiber, other than the glass fiber may be used together with the glass fiber, as long as the advantages of this embodiment are not significantly impaired.

The glass fiber used in this embodiment will now be described in detail.

Any type of glass fiber may be used without limitation. Examples of the glass used for fiber may include E-glass, C-glass, A-glass, and S-glass. Out of them, E-glass is used in one preferred embodiment. Any known method may be employed to produce the glass fiber without limitation.

Two or more types of glass fiber may be used together.

The fiber length falls within a range from 2 to 20 mm in one preferred embodiment, and from 3 to 10 mm in one more preferred embodiment. The fiber length within these ranges allows a molding, which may be formed from the resin composition of this embodiment, to have high rigidity, and contributes to an increase in impact resistance. Specifically, a glass fiber length shorter than 2 mm may degrade the physical properties, such as rigidity, of the resin composition and its molding. On the other hand, a glass fiber length longer than 20 mm may reduce fluidity. This may hinder manufacturing of such moldings in an industrial scale. Such long fiber may degrade the appearance of the surface, and are thus less applicable to industrial products.

In this specification, the “fiber length” is the length of glass fiber used as a material before being melt-kneaded, if the glass fiber is ordinal roving or strand fiber. If glass-fiber-containing pellets is used, each of which is obtained by aggregating and integrating continuous glass fibers by melt extrusion to be described later, the “fiber length” is defined as follows. In the case of the glass-fiber-containing pellets, the length of a side of each pellet (e.g., in the extrusion direction) is substantially equal to the lengths of the fibers in the pellet. Thus, the length of the side of the pellet (e.g., in the extrusion direction) is referred to as the fiber length.

Specifically, the term “substantially” here means that the length of a side of each pellet (e.g., in the extrusion direction) is equal to the lengths of 50% or more, and 90% or more in one preferred embodiment, of all the fibers in the glass-fiber-containing pellet. The glass fibers are hardly broken or damaged during preparation of the pellets.

In this specification, the fiber length is measured as follows. Resin composition pellets or their molding are/is burnt or dissolved so that the glass fiber (B) remains. The remaining glass fiber (B) is, for example, diffused on the glass plate, and then measured using a digital microscope. The average length is calculated using the lengths of 100 or more fibers measured by this method.

The measurement using the digital microscope is specifically performed as follows. The glass fibers are mixed with surfactant-containing water. The mixture is dropped and diffused on a thin glass plate. The lengths of 100 or more glass fibers are then measured using a digital microscope (e.g., VHX-900 manufactured by Keyence Corporation), and the average is calculated.

The diameter of the glass fiber falls within a range from 3 to 25 μm in one preferred embodiment, and from 6 to 20 μm in one more preferred embodiment. A fiber diameter smaller than 3 μm may readily break or damage the glass fibers in producing or molding of the resin composition and its molding. On the other hand, a fiber diameter larger than 25 μm reduces the aspect ratio of the glass fiber. This may degrade various characteristics, such as rigidity, of the resin composition and its molding.

The fiber diameter is calculated as follows. The glass fibers are cut in a direction perpendicular to the fiber lengths. The cross-section is observed with a microscope to measure the diameter. The average of the diameters of 100 or more glass fibers is calculated.

The surface of the glass fiber may be treated or untreated. In order to, for example, improve the dispersion of the glass fiber in the polypropylene-based resin, the surface of the glass fiber is treated in one preferred embodiment with, for example, an organic silane coupling agent, a titanate coupling agent, an aluminate coupling agent, a zirconate coupling agent, a silicone compound, a higher fatty acid, a fatty acid metal salt, or a fatty acid ester.

The glass fiber may be subjected to sizing (surface) treatment with a sizing agent. Examples of the sizing agent may include epoxy-based, aromatic urethane-based, aliphatic urethane-based, acrylic-based, and maleic anhydride-modified polyolefin-based sizing agents. These sizing agents melt at 200° C. or lower in one preferred embodiment, because they need to melt while being melt-knead with the polypropylene-based resin.

The surface of the glass fiber may be treated or untreated. In order to, for example, improve the dispersion of the glass fiber in the polypropylene-based resin, the surface of the glass fiber is treated in one preferred embodiment with, for example, an organic silane coupling agent, a titanate coupling agent, an aluminate coupling agent, a zirconate coupling agent, a silicone compound, a higher fatty acid, a fatty acid metal salt, or a fatty acid ester.

Examples of the organic silane coupling agents used for surface treatment may include vinyltrimethoxysilane, γ-chloropropyltrimethoxysilane, γ-methacryloxypropyltrimethoxysilane, γ-aminopropyltrimethoxysilane, and 3-acryloxypropyltrimethoxysilane. Examples of the titanate coupling agent may include isopropyltriisostearoyl titanate, isopropyltris(dioctyl pyrophosphate) titanate, and isopropyltri(N-aminoethyl) titanate. Examples of the aluminate coupling agent may include acetoalkoxyaluminium diisopropylate. Examples of the zirconate coupling agent may include tetra(2,2-diallyloxymethyl)butyl di(tridecyl)phosphite zirconate, and neopentyl(diallyl)oxy trineodecanoyl zirconate. Examples of the silicone compound may include silicone oil and silicone resin.

Examples of the higher fatty acid used for surface treatment may include oleic acid, capric acid, lauric acid, palmitic acid, stearic acid, montanoic acid, caleic acid, linoleic acid, rosin acid, linolenic acid, undecanoic acid, and undecenoic acid. Examples of the higher fatty acid metal salt may include sodium, lithium, calcium, magnesium, zinc, and aluminum salts of fatty acids having nine or more carbon atoms, such as stearic acid and montanoic acid. Out of these, calcium stearate, aluminum stearate, calcium montanate, and sodium montanate are used advantageously. Examples of the fatty acid ester include polyhydric alcohol fatty acid ester such as glycerin fatty acid ester, a-sulfone fatty acid ester, polyoxyethylene sorbitan fatty acid ester, sorbitan fatty acid ester, polyethylene fatty acid ester, and sucrose fatty acid ester.

The amount of the surface treating agent to be used is not particularly limited. The amount falls within a range from 0.01 to 5 parts by mass in one preferred embodiment, and from 0.1 to 3 parts by mass in one more preferred embodiment, relative to 100 parts by mass of the glass fiber.

The glass fiber may be used in the form of so-called chopped strand glass fiber formed by cutting raw fiber into strands with a desired length. In particular, chopped strand glass fiber, which is formed by cutting bundled glass fiber strands into a length of 2 mm to 20 mm, is used in one preferred embodiment in view of low shrinkage resistance, rigidity, and impact strength of the resin composition and its molding.

A lot of companies place various glass fiber products on the market. Specific examples may include T480H manufactured by Nippon Electric Glass Co., Ltd.

These examples of the glass fiber may be used as “glass-fiber-containing pellets.” Each of the “glass-fiber-containing pellets” is obtained by aggregating and integrating continuous glass fibers with any amount of, for example, the propylene-ethylene block copolymer (A) in advance by melt-extrusion. The use of “glass-fiber-containing pellets” is advantageous in view of increasing the transferability to embossed surfaces and rigidity of the resin composition and its molding.

In the case of the glass-fiber-containing pellets, the fiber length is, as described above, the fiber length of each glass-fiber-containing pellet (in the extrusion direction), which falls within a range from 2 to 20 mm in one preferred embodiment.

Any known method may be employed to produce such glass-fiber-containing pellets without limitation.

The glass fiber content in the glass-fiber-containing pellet falls within a range from 20 mass % to 70 mass % relative to the total amount (i.e., 100 mass %) of the pellet in one preferred embodiment.

If glass-fiber-containing pellets with a glass fiber content lower than 20 mass % are used in this embodiment, a large number of pellets are required to provide the resin composition and its molding with physical properties such as rigidity. This may hinder manufacturing of such moldings in an industrial scale. On the other hand, if glass-fiber-containing pellets with a glass fiber content higher than 70 mass % are used in this embodiment, production of the pellets itself may be difficult.

### Content

The content of the glass fiber (B) used in this embodiment falls within a range from 10 to 20 mass %, from 10 to 18 mass % in one preferred embodiment, from 12 to 17 mass % in one more preferred embodiment, and from 13 to 16 mass % in one further more preferred embodiment, where the sum of the components (A), (B), (C), and (D) is 100 mass %. The glass fiber (B) content within these ranges allows a molding, which may be formed from the resin composition of this embodiment, to have high rigidity and impact resistance. This enables production of such a resin composition in an industrial scale. Specifically, a glass fiber (B) content lower than 10 mass % may reduce physical properties such as rigidity and impact resistance. A glass fiber (B) content higher than 20 mass % may hinder production of pellets itself.

The glass fiber (B) content is indicated by a net mass. For example, if the glass-fiber-containing pellets are used, the glass fiber (B) content is measured based on the net mass of the glass fiber (B) contained in the pellets.

### 3. Component (C)

The component (C) used in this embodiment satisfies requirements (C-i) and (C-ii).

(C-i) The component (C) is an ethylene-octene copolymer with a density of 0.85 g/cm³ to 0.87 g/cm³.

(C-ii) A melt flow rate of the component (C) (at 230° C. and a load of 2.16 kg) falls within a range from 0.5 g/10 min to 1.0 g/10 min

The ethylene-octene copolymer, which is the component (C) used in this embodiment, provides the resin composition and its molding with characteristics such as a small gloss change after thermal duration and high impact resistance.

Two or more types may be used together as the component (C).

### (1) Requirements

### (C-i) Density

The density of the component (C) used in this embodiment falls within a range from 0.85 to 0.87 g/cm³, and 0.855 to 0.865 g/cm³ in one preferred embodiment. The density of the component (C) within these ranges enables excellent dispersion of the propylene-ethylene block copolymer (A) and the component (C). Thus, a molding, which may be formed from the resin composition of this embodiment, has a surface with a small gloss change after thermal duration, as well as high impact resistance and low initial gloss. Specifically, a density smaller than 0.85 g/cm³ may increase (or degrade) the gloss change of the resin composition and its molding after thermal duration. A density larger than 0.87 g/cm³ may reduce impact resistance and increase initial gloss.

The component (C) used in this embodiment is the ethylene-octene copolymer with the density described above. The use of the ethylene-octene copolymer as the component (C) is advantageous in view of allowing the resin composition and its molding to have a small gloss change after thermal duration, excellent properties such as impact strength, and cost efficiency.

### (C-ii) Melt Flow Rate (MFR)

The melt flow rate (MFR) of the component (C) used in this embodiment (at 230° C. and a load of 2.16 kg) falls within a range from 0.5 to 1.1 g/10 min, from 0.6 to 1.05 g/10 min in one preferred embodiment, and from 0.7 to 1.0 g/10 min in one more preferred embodiment. The MRF of the component (C) within these ranges enables excellent dispersion of the propylene-ethylene block copolymer (A) and the component (C). Thus, a molding, which may be formed from the resin composition of this embodiment, has a surface with a small gloss change after thermal duration, as well as high impact resistance and low initial gloss. Specifically, an MFR lower than 0.5 g/10 min may increase the initial gloss of the resin composition and its molding. On the other hand, an MFR higher than 1.1 g/10 min may increase (or degrade) the gloss change after thermal duration.

### (2) Producing Method

The ethylene-octene copolymer, which is the component (C) used in this embodiment, is produced by polymerizing ethylene and octene monomers in presence of a catalyst.

Examples of the catalyst include titanium compounds such as titanium halides, organoaluminum-magnesium complexes such as alkylaluminum-magnesium complexes, Ziegler catalysts such as alkylaluminum and alkylaluminum chloride; and metallocene-based catalysts described in, for example, PCT International Publication WO91/04257.

Polymerization may be performed by a production process such as a gas-phase fluidized-bed process, a solution process, and a slurry process.

A lot of companies place various ethylene-octene copolymer products on the market. Any product with desired physical properties is available for use.

### (3) Content

The content of the component (C) used in this embodiment falls within a range from 15 to 25 mass %, from 17 to 23 mass % in one preferred embodiment, and from 18 to 22 mass % in one more preferred embodiment, where the sum of the components (A), (B), (C), and (D) is 100 mass %. The component (C) content within these ranges allows a molding, which may be formed from the resin composition of this embodiment, to have a small gloss change after thermal duration, high impact resistance, and high rigidity. Specifically, a component (C) content lower than 15 mass % may reduce impact resistance and increase (or deteriorate) the gloss change after thermal duration. On the other hand, a component (C) content higher than 25 mass % may reduce the rigidity of the resin composition of this embodiment and its molding.

### 4. Component (D)

The component (D) of this embodiment satisfies a requirement (D-i).

(D-i) The component (D) is an acid-modified polyolefin and/or a hydroxy-modified polyolefin.

The use of an acid-modified polyolefin and/or a hydroxy-modified polyolefin as the component (D) increases the strength of the interface between the propylene-ethylene block copolymer (A) and the glass fiber (B). An increase in the interface strength effectively improves the physical properties, such as rigidity and impact strength, of the resin composition and its molding.

(1)(D-i): Acid-Modified Polyolefin and/or Hydroxy-Modified Polyolefin

Any generally known type of acid-modified polyolefin may be used without limitation. The acid-modified polyolefin is modified by graft copolymerization of a polyolefin using with an unsaturated carboxylic acid. Examples of the acid-modified polyolefin include polyethylene, polypropylene, an ethylene-α-olefin copolymer, an ethylene-α-olefin-unconjugated diene compound copolymer (e.g., EPDM), or an ethylene-aromatic monovinyl compound-conjugated diene compound copolymer rubber. Examples of the unsaturated carboxylic acid include maleic acid or maleic anhydride. The graft copolymerization is performed by allowing, for example, any type of polyolefin listed above to react with the unsaturated carboxylic acid in a suitable solvent using a radical generator such as benzoyl peroxide. A component of the unsaturated carboxylic acid or its derivative may be introduced in the polymer chain by random or block copolymerization of the component with a monomer for the polyolefin.

The hydroxyl-modified polyolefin is a modified polyolefin containing a hydroxyl group. The modified polyolefin may have a hydroxyl group at any suitable position, for example, main chain terminals or side chains. Examples of the olefin resin forming the hydroxyl-modified polyolefin may include a homopolymer or copolymer of an α-olefin such as ethylene, propylene, butene, 4-methylpentene-1, hexene, octene, nonene, decene, or dodecene, or a copolymer of any of these types of a-olefin and a copolymerizable monomer. Examples of the hydroxyl-modified polyolefin may include hydroxyl-modified polyethylene (e.g., low-, medium-, and high-density polyethylene, linear low-density polyethylene, ultrahigh molecular weight polyethylene, an ethylene-(meth)acrylic acid ester copolymer, and an ethylene-vinyl acetate copolymer), and hydroxyl-modified polypropylene (e.g., a polypropylene homopolymer such as isotactic polypropylene, a random copolymer of propylene and an α-olefin (e.g., ethylene, butene, or hexane), and a propylene-α-olefin block copolymer); and hydroxyl-modified poly(4-methylpentene-1).

### (2) Content

The content of the glass fiber (B) used in this embodiment falls within a range from 0.5 to 2 mass %, from 0.7 to 1.5 mass % in one preferred embodiment, from 0.8 to 1.2 mass % in one more preferred embodiment, and from 0.9 to 1.1 mass % in one further more preferred embodiment, the sum of the components (A), (B), (C), and (D) is 100 mass %. The component (D) content within these ranges allows a molding, which may be formed from the resin composition of this embodiment, to have high rigidity and scratch resistance, and readily provides such moldings. Specifically, a component (D) content lower than 0.5 mass % may reduce rigidity and scratch resistance. On the other hand, a component (D) content higher than 2 mass % may reduce fluidity. This may hinder manufacturing of such moldings itself.

### 5. Component (E)

The component (E) of this embodiment satisfies a requirement (E-i).

(E-i) The component (E) is erucic acid amide.

The erucic acid amide reduces the friction on the surface of the resin composition of this embodiment. This contributes to a further increase in, for example, scratch resistance and moldability.

The erucic acid amide has properties to reduce blush marks, which may occur in contact or collision with an external object in molding, distributing, and using a molding to be formed from the resin composition of this embodiment. The erucic acid amide also reduces adhesion of dust in storage.

### Content

The content of the erucic acid amide used in this embodiment falls within a range from 0.05 to 0.15 pts.mass, from 0.06 to 0.14 pts.mass in one preferred embodiment, from 0.08 to 0.12 pts.mass in one more preferred embodiment, and from 0.09 to 0.11 pts.mass in one particularly preferred embodiment, relative to 100 pts.mass of the sum of the components (A), (B), (C), and (D). The erucic acid amide content within these ranges allows a molding, which may be formed from the resin composition of this embodiment, to have high scratch resistance, a surface with a small gloss change after thermal duration, and low initial gloss. Specifically, an erucic acid amide content larger than 0.05 pts.mass may allow erucic acid amide to bleed out onto the molding surface of a molding, which may be formed from the resin composition of this embodiment, to increase (or degrade) a gloss change of the surface of the molding after thermal duration or to increase initial gloss. An erucic acid amide content smaller than 0.15 pts.mass may reduce scratch resistance.

### 6. Optional Additional Component

The resin composition of this embodiment may contain, as an optional additional component, various types of components such as a molecular weight depressant and an antioxidant, as long as the advantages of this embodiment are not significantly impaired.

Two or more types of optional additional components may be used together. The optional additional component may be added to the resin composition, or to the components such as the propylene-ethylene block copolymer (A) in advance. Two or more types of optional additional components may be used together for the components. In this embodiment, the content of the optional additional component is not particularly limited. The content usually falls within a range from about 0.01 to about 0.5 pts.mass relative to 100 pts.mass of the resin composition, and may be selected as appropriate in accordance with the purpose.

### (1) Molecular Weight Depressant

The molecular weight depressant effectively provides or improves, for example, moldability (fluidity).

For example, an organic peroxide or a so-called decomposition (oxidation) promoter may be used as the molecular weight depressant. An organic peroxide is used advantageously.

The organic peroxide is, for example, one or more selected from the group consisting of benzoyl peroxide, t-butyl perbenzoate, t-butyl peracetate, t-butylperoxyisopropyl carbonate, 2,5-di-methyl-2,5-di-(benzoylperoxy)hexane, 2,5-di-methyl-2,5-di-(benzoylperoxy)hexyne-3, t-butyl di-peradipate, t-butylperoxy-3,5,5-trimethylhexanoate, methyl-ethyl ketone peroxide, cyclohexanone peroxide, di-t-butyl peroxide, dicumyl peroxide, 2,5-di-methyl-2,5-di-(t-butylperoxy)hexane, 2,5-di-methyl-2,5-di-(t-butylperoxy)hexyne-3, 1,3-bis-(t-butylperoxyisopropyl)benzene, t-butylcumyl peroxide, 1,1-bis-(t-butylperoxy)-3,3,5-trimethylcyclohexane, 1,1-bis-(t-butylperoxy)cyclohexane, 2,2-bis-t-butylperoxybutane, p-menthane hydroperoxide, di-isopropylbenzene hydroperoxide, cumene hydroperoxide, t-butyl hydroperoxide, p-cymene hydroperoxide, 1,1,3,3-tetra-methylbutyl hydroperoxide, and 2,5-di-methyl-2,5-di-(hydroperoxy)hexane.

### (2) Antioxidant

The antioxidant effectively prevents or reduces degradation in the quality of the resin composition and its molding.

Examples of the antioxidant may include a phenol-based antioxidant, a phosphorus-based antioxidant, and a sulfur-based antioxidant.

### (3) Others

The resin composition of this embodiment may contain thermoplastic resin, such as polyolefin-based resin, polyamide resin, and polyester resin, other than the above-described examples or an elastomer (a rubber component) other than the ethylene-octene copolymer of the component (C), as long as the advantages of this embodiment are not significantly impaired.

A lot of companies place various products of these types of optional components on the market. Any desired product is available for use in accordance with the purpose.

### 7. Producing Method of Fiber-Reinforced Polypropylene-Based Resin Composition

The fiber-reinforced polypropylene-based resin composition may be produced as follows. The glass fiber (B), the ethylene-octene copolymer (C), the acid-modified polyolefin and/or the hydroxy-modified polyolefin (D), the erucic acid amide (E), and, if necessary, the optional additional component are mixed with the propylene-ethylene block copolymer (A) at the ratio described above by a generally known method. The mixture is subjected to a kneading step (melt-kneading), thereby producing the resin composition.

The mixing is generally performed with a mixer, such as a tumbler, a V-blender, or a ribbon blender. In the melt-kneading, the mixture is generally (semi-)melt-kneaded using a kneading machine such as a single-screw extruder, a twin-screw extruder, a Banbury mixer, a roll mixer, a Brabender Plastograph, a kneader, or a stirring granulator, and granulated. In producing the resin composition by the (semi-)melt-kneading and granulation, the components are kneaded at the same time or at different times to improve the properties of the resin composition. If the components are kneaded at different times, for example, a part or all of the propylene-ethylene block copolymer (A) and a part of the glass fiber (B) are kneaded first, and then the other components are kneaded and granulated.

In one preferred embodiment, the resin composition of this embodiment is produced such that the glass fiber (C), which is present in the resin composition pellets obtained through the kneading step or in their molding, has an average length of 0.3 mm or more, and 0.4 mm to 2.5 mm in one preferred embodiment.

In this specification, the average length of the glass fiber (B) present in the resin composition pellets or a molding obtained therefrom is the average of the values measured with a digital microscope. A specific method for measurement is the same as or similar to the above-described method of measuring the glass fiber (B).

One preferred method of producing the resin composition is, for example, as follows. For example, the propylene-ethylene block copolymer (A), the ethylene-octene copolymer (C), the acid-modified polyolefin and/or the hydroxy-modified polyolefin (D) and the erucic acid amide (E) are sufficiently melt-kneaded with a twin-screw extruder. Then, the glass fiber (B) is fed by, for example, a side feed method to disperse sized fibers, while minimizing or reducing breakages and damages of the glass fiber.

Another method is so-called stirring granulation. For example, the propylene-ethylene block copolymer (A) and the other components are stirred in a Henschel mixer at a high speed to be semi-melted. In this state, the glass fiber (B) is kneaded in the mixture. This stirring granulation is also one of the preferred producing methods, because glass fibers can be readily dispersed, while minimizing or reducing breakages and damages of the glass fibers.

In an alternative producing method, the components other than the glass fiber (B) are melt-kneaded into pellets in advance using an extruder. These pellets are mixed with the “glass-fiber (B)-containing pellets” to obtain the fiber-reinforced polypropylene-based resin composition. This is also one of the preferred producing methods for at least the same reasons described above.

As described above, in one preferred producing method of the fiber-reinforced polypropylene-based resin composition of this embodiment, the components other than the glass fiber (B) is kneaded in the kneading step, and then, the glass fiber (B) is added. The resin composition of this embodiment may be produced such a simple method.

### 8. Manufacturing Method and Characteristics of Molding

The resin composition of this embodiment manufactured by the method is applicable to various types of molding methods so as to be a molding. A desired molding can be obtained by molding the resin composition by a well-known molding method such as injection molding (including gas injection molding, two-color injection molding, core-back injection molding, sandwich injection molding), injection compression molding (press injection), extrusion molding , sheet molding and blow molding. Out of these, the molding is obtained by the injection molding or the injection compression molding in one preferred embodiment.

A molding, which may be formed from the resin composition of this embodiment, has characteristics such as an embossed surface with low initial gloss, and a small gloss change after thermal duration. More significant characteristics of the molding to be formed from the resin composition of this embodiment are high rigidity and high scratch resistance.

The molding to be formed from the resin composition of this embodiment is manufactured by the simple method at low costs using readily available and cost effective components.

The molding is thus advantageously used for, for example, vehicle interior and exterior components such as dashboards, glove boxes, console boxes, armrests, grip knobs, various trims such as door trims, ceiling components, various housings, pillars, mud guards, bumpers, fenders, rear doors, and fan shrouds; and components in engine compartments; as well as components of electric and electronic appliances such as televisions and vacuum cleaners, various industrial components, house components such as toilet seats, and building components. In particular, the molding is advantageously used for vehicle components, particularly interior components, due to its low gloss and high scratch resistance.

### EXAMPLES

This embodiment will be described more in detail using examples, which are however not intended to limit the scope of this embodiment.

The following evaluation and analysis methods, and materials were used in the examples.

### 1. Evaluation and Analysis Methods

### (1) Rigidity (Bending Elastic Modulus: FM)

The rigidity was measured in accordance with JIS K7171 at a temperature of 23° C. A test piece for physical property evaluation fabricated under the following conditions was used.
Molding machine: Injection Molding Machine EC20 manufactured by TOSHIBA MACHINE CO., LTD
Mold: mold for two strip-like test pieces (10×80×4 t (mm)) for physical properties evaluation
Molding Conditions
   Molding temperature: 220° C.
   Temperature of mold: 40° C.
   Injection pressure: 50 MPa
   Injection period: 5 sec
   Cooling period: 20 sec
      (2) Impact Strength (Charpy Impact Strength (with Notch))

The impact strength was measured in accordance with JIS K7111 at a temperature of 23° C. A test piece for physical property evaluation was used, which was fabricated like the test piece for the measurement of the rigidity (the bending elastic modulus).

(3) Gloss Change after Thermal Duration

The following test piece for evaluation was prepared. The gloss at an initial stage and after standing for ten hours in an oven at a temperature of 115° C., and the rate of gloss change were measured.
Test piece: flat plate with a size of 120×120×3 t (mm)
Measured Surface

The plane surface of the test piece has the following design.
Embossed surface: embossed satin surface of vehicle interior
Embossing depth: 30 μm
Molding machine: Injection Molding Machine IS100GN manufactured by TOSHIBA MACHINE CO., LTD
Molding Conditions
   Molding temperature: 220° C.
   Temperature of mold: 40° C.
   Injection pressure: 50 MPa
   Injection period: 10 sec
   Cooling period: 20 sec
Glossmeter: VG-2000 manufactured by Nippon Denshoku Industries Co., Ltd.

The gloss was measured at an angle of 60° from the plane surface of the test piece. A test piece under the following conditions was determined as reaching a practical level. The initial gloss was equal to or lower than 2.3. The difference between the initial gloss and the gloss after the 10-hour standing was smaller than 0.8.

### (4) Scratch Resistance

A test piece was used, which was fabricated like the test piece for the gloss evaluation.
Scratch tester: Auto Cross Cut Tester manufactured by YASUDA SEIKI SEISAKUSHO, LTD.
Measurement Method In the above-described tester, the surface of a test piece was scratched at a scratch speed of 1000 mm/min and a load of 200 g using a sapphire scratch needle having a curvature radius of 0.5 mm at the edge. The degree of damage of the scratched surface was determined visually.

∘: A small change was acknowledged.

×: There was a significant change.

### (5) Melting Peak Temperature (Tm)

The peak temperature was measured using DSC6200 manufactured by Seiko Instruments Inc. First, 5.0 mg of a sample was taken, maintained at 200° C. for five minutes and then crystallized to 40° C. at a temperature drop rate of 10° C./min The sample was further melted at a temperature rise rate of 10° C./min

### (6) Melt Flow Rate (MFR) Component (A)

The MFR of the component (A) was measured in accordance with JIS K7210 at a temperature of 230° C. and a load of 2.16 kg.

### (7) Q Value

Twenty gram of a specimen was dissolved in 10 ml of a solvent. The Q value was calculated as below based on the ratio (Mw/Mn) of the mass average molecular weight (Mw) to the number average molecular weight (Mn), which are measured by the gel permeation chromatography (GPC).

Apparatus: GPC 150C manufactured by Waters Corporation

Detector: 1A Infrared Spectrophotometer (with a measurement wavelength of 3.42 μm) manufactured by MIRAN

Column: three columns of AD806M/S manufactured by Showa Denko K.K. The columns were calibrated with measuring monodisperse polystyrene manufactured by Tosoh Corporation (0.5 mg/mL solutions of A500, A2500, F1, F2, F4, F10, F20, F40, and F288), and approximating logarithmic values of elution volume and molecular weight by a quadratic expression. The molecular weight of a sample was obtained by conversion into polypropylene using viscosity equations of polystyrene and polypropylene, where coefficients of the viscosity equation of polystyrene: α=0.723 and log K=−3.967, and coefficients of the viscosity equation of polypropylene: α=0.707 and log K=−3.616).

Measurement temperature: 140° C.

Concentration: 20 mg/10 ml

Amount of injection: 0.2 ml

Solvent: o-dichlorobenzene

Flow rate: 1.0 ml/min

### (8) Fiber Length

Resin composition pellets or a molding were/was burnt or dissolved so that the component (B) remained. The remaining component (B) was, for example, diffused on the glass plate, and then measured using a digital microscope (e.g., VHX-900 manufactured by Keyence Corporation). The average length was calculated using the lengths of 100 or more fibers measured by this method.

### (9) Ethylene Content and Specification of (A-A) and (A-B) in Component (A)

The ethylene content was measured by the methods described in this specification and in Japanese Unexamined Patent Publication No. 2013-067789.

### (10) Peak of Tan δ Curve in Solid Viscoelasticity Measurement

The peak was measured by solid viscoelasticity measurement. As the sample, a strip with a width of 10 mm, a length of 18 mm, and a thickness of 2 mm is used, which has been cut out of a sheet having a thickness of 2 mm and being subjected to injection molding under the following conditions.

The apparatus ARES manufactured by Rheometric Scientific, Inc. is used.

Standard No.: JIS-7152 (ISO294-1)

Frequency: 1 Hz

Measurement temperature: The sample is heated gradually from −60° C. to be melted.

Strain: within a range from 0.1 to 0.5%

Molding machine: Injection Molding Machine EC20 manufactured by TOSHIBA MACHINE CO., LTD
Mold: strip-like test piece (60×80×2 t (mm)) for physical properties evaluation
Molding Conditions
   Molding temperature: 220° C.
   Temperature of mold: 40° C.
   Injection pressure: 50 MPa
   Injection period: 5 sec
   Cooling period: 20 sec

### 2. Material

### (1) Component (A)

A-1: WELNEX™ manufactured by Japan Polypropylene Corporation,

a propylene-ethylene block copolymer produced using a metallocene-based catalyst, and having an MFR of 55 g/10 min (at 230° C. and a load of 2.16 kg), an ethylene content of 3.8 mass %, a Q value of 2.7, and a melting peak temperature (Tm) of 130° C.

The ethylene content of the propylene-ethylene random copolymer (A-A) of the first step was 2.2 mass %. The composition ratio of the copolymer (A-A) was 80 mass %. The ethylene content of the propylene-ethylene random copolymer (A-B) of the second step was 10.5 mass %. The composition ratio of the copolymer (A-B) was 20 mass %. The tan δ curve had a single peak at −11° C.
A-2: NOVATEC BC03HR manufactured by Japan Polypropylene Corporation

a propylene-ethylene block copolymer produced using a Ziegler-based catalyst, and having an MFR of 27 g/10 min (at 230° C. and a load of 2.16 kg), an ethylene content of 10.8 mass %, a Q value of 6.5, and a melting peak temperature (Tm) of 161° C.

The ethylene content of the propylene-ethylene random copolymer (A-A) of the first step was 0 mass % (i.e., a homopolymer). The composition ratio of the copolymer (A-A) was 73 mass %. The ethylene content of the propylene-ethylene random copolymer (A-B) of the second step was 40 mass %. The composition ratio of the copolymer (A-B) was 27 mass %. The tan δ curve had peaks in two portions (at −1.8° C. and −40° C.).

### (2) Component (B)

B-1: T480H (manufactured by Nippon Electric Glass Co., Ltd.)

glass fiber of a chopped strand type with a fiber diameter of 10 μm and a length of 8 mm
C-2: Talc (manufactured by Fuji Talc Industrial Co., Ltd.)

with an average particle size of 6.3 μm (at a catalog value)

### (3) Component (C)

The following densities are indicated by the catalog values of products.
C-1: Engage EG8150 (manufactured by Dow Chemical Company)

an ethylene-octene copolymer elastomer with an MFR of 1 g/10 min (at 230° C. and a load of 2.16 kg) and a density of 0.868 g/cm³ in the form of pellets
C-2: Engage EG8100 (manufactured by Dow Chemical Company)

an ethylene-octene copolymer elastomer with an MFR of 2 g/10 min (at 230° C. and a load of 2.16 kg) and a density of 0.870 g/cm³ in the form of pellets

### (4) Component (D)

D1: maleic anhydride-modified polypropylene (OREVAC CA100) manufactured by Arkema Inc. with an acid modification ratio (graft ratio) of 0.8 mass %

### (5) Component (E)

E-1: NEUTRON-S (erucic acid amide manufactured by Nippon Fine Chemical Co., Ltd.)

### 3. Examples and Comparative Examples

### Example 1 and Comparative Examples 1 and 2

### (1) Production of Resin Composition

The components (A) to (E) described above were mixed together with an additive, which will be described below, at the ratio indicated by Table 3. The mixture was kneaded and granulated into resin pellets under the following conditions.

At this time, 0.1 parts by mass of IRGANOX 1010 manufactured by BASF and 0.05 parts by mass of IRGAFOS 168 manufactured by BASF were added relative to 100 parts by mass of the entire composition composed of the components (A) to (E).

Kneader: twin-screw extruder KZW-15-MG manufactured by Technovel Corporation

Kneading Conditions
Temperature: 200° C.
Rotation rate of screw: 400 rpm
Discharge rate: 3 kg/h

The glass fiber (B-1) of the component (B) was side-fed in a middle of the extruder. The average length of the glass fibers (B-1) contained in the obtained resin pellets fell within a range from 0.45 mm to 0.7 mm.

### (2) Molding and Evaluation of Resin Composition

The resin composition was molded and evaluated by the method described above using the obtained pellets. Table 3 shows a result.

TABLE 3

| | | | | Comp. Ex. | Comp. Ex. |
|---|---|---|---|---|---|
| | | Unit | Ex.1 | 1 | 2 |
| Component (A) | A-1 | mass % | 64 | | 64 |
| | A-2 | mass % | | 64 | |
| Component (B) | B-1 | mass % | 15 | | 15 |
| | B-2 | mass % | | 15 | |
| Component (C) | C-1 | mass % | 20 | 20 | |
| | C-2 | mass % | | | 20 |
| Component (D) | D-1 | mass % | 1 | 1 | 1 |
| Component (E) | E-1 | pts. mass | 0.1 | 0.1 | 0.1 |
| Tensile Elastic Modulus | | MPa | 2100 | 1500 | 2100 |
| Impact Strength | | kJ/m² | 21 | 35 | 25 |
| Scratch Resistance | | | ∘ | x | ∘ |
| Gloss Change | Initial Stage | | ∘ | x | ∘ |
| | 115° C. × 100 h | | ∘ | ∘ | x |

### 4. Evaluation

It is found from the result shown in Table 3 that Example 1, which meets the requirements for the resin composition of this embodiment and its molding, has the features of: not only high rigidity and impact resistance and low initial gloss, but also a small gloss change after thermal duration, and a high scratch resistance.

On the other hand, in the comparative examples, which fail to meet the requirements of this embodiment, the resin compositions with the compositions shown in Comparative Examples 1 and 2 and their moldings have unbalanced, poor properties, as compared to the Example 1.

For example, Comparative Example 1 contains talc as the component (B), which has lower scratch resistance and a larger gloss change than the component (B) of Example 1. In addition, Comparative Example 1 has lower impact resistance, higher initial gloss, and a larger gloss change after thermal duration. In Comparative Example 2, the thermoplastic elastomer (C) fails to meet the requirements, and thus has a large gloss change after thermal duration.

1. A fiber-reinforced polypropylene-based resin composition comprising:
53 mass % to 74.5 mass % of a component (A);
10 mass % to 20 mass % of a component (B);
15 to 25 mass % of a component (C); and
0.5 to 2 mass % of a component (D);
where a sum of the components (A), (B), (C), and (D) is 100 mass %,
the components (A), (B), (C), and (D) satisfying conditions indicated below, wherein
the composition further comprises 0.05 to 0.15 pts.mass of a component (E),
relative to 100 pts.mass of the sum of the components (A), (B), (C), and (D),
the component (E) satisfying a condition indicated below,
the component (A) satisfies requirements defined by:
(A-i) the component (A) is a propylene-ethylene block copolymer obtained by sequential polymerization of 30 mass % to 95 mass % of a component (A-A) in a first step and 70 mass % to 5 mass % of a component (A-B) in a second step using a metallocene-based catalyst, where the component (A-A) is a propylene homopolymer component or a propylene-ethylene random copolymer component containing 7 mass % or less of ethylene, the component (A-B) is a propylene-ethylene random copolymer component containing 3 mass % to 20 mass % more ethylene than the component (A-A),
(A-ii) a melting peak temperature (Tm) measured by DSC falls within a range from 110° C. to 150° C.,
(A-iii) a tan δ curve has a single peak at 0° C. or lower in a temperature-loss tangent curve obtained by solid viscoelasticity measurement, and
(A-iv) a melt flow rate (MFR) of the component (A) (at 230° C. and a load of 2.16 kg) falls within a range from 0.5 g/10 min to 200 g/10 min,
the component (B) satisfies a requirement defined by:
(B-i) the component (B) is glass fiber,
the component (C) satisfies requirements defined by:
(C-i) the component (C) is an ethylene-octene copolymer with a density of 0.85 g/cm³ to 0.87 g/cm³, and
(C-ii) a melt flow rate of the component (C) (at 230° C. and a load of 2.16 kg) falls within a range from 0.5 g/10 min to 1.1 g/10 min,
the component (D) satisfies a requirement defined by:
(D-i) the component (D) is an acid-modified polyolefin and/or a hydroxy-modified polyolefin, and
the component (E) satisfies a requirement defined by
(E-i) the component (E) is erucic acid amide.

2. The composition of claim 1, wherein
the component (B) has a length within a range from 0.2 mm to 10 mm.
